(19) United States
(12) Patent Application Publication
(10) Pub. No.: US 2026/0043101 A1
(43) Pub. Date: Feb. 12, 2026

(54) ADJUSTING CARBON CONTENT IN DIRECT REDUCED IRON

(71) Applicant: PRIMETALS TECHNOLOGIES AUSTRIA GMBH, Linz (AT)

(72) Inventors: Bernhard HIEBL, Wilhering (AT); Norbert REIN, Wien (AT); Johann WURM, Bad Zell (AT); Karl-Heinz ZELLINGER, Linz (AT)

(73) Assignee: PRIMETALS TECHNOLOGIES AUSTRIA GMBH, Linz (AT)

(21) Appl. No.: 19/139,449

(22) PCT Filed: Dec. 13, 2023
(86) PCT No.: PCT/EP2023/085654

§ 371 Date: Jun. 16, 2025

(30) Foreign Application Priority Data
Dec. 19, 2022 (EP) 22214537.7
Apr. 18, 2023 (EP) 23168511.6

(51) Int. Cl. C21B 13/00

(52) U.S. Cl. CPC C21B 13/0046; C21B 13/0073

(57) ABSTRACT

A method for introducing carbon into direct reduced iron (DRI), wherein at least one solid carbon carrier is added to the DRI, and the DRI is hardened once the solid carbon carrier has been added to the DRI.

### CROSS-REFERENCE TO RELATED APPLICATIONS

The present application is a national phase application of PCT Application No. PCT/EP2023/85654, filed Dec. 13, 2023, entitled “ADJUSTING CARBON CONTENT IN DIRECT REDUCED IRON”, which claims the benefit of European Patent Application No. 22214537.7, filed Dec. 19, 2022, and European Patent Application No. 23168511.6, filed Apr. 18, 2023, each of which is incorporated by reference in its entirety.

### BACKGROUND OF THE INVENTION

### 1. Field of the Invention

The application relates to a process for introducing carbon into direct reduced iron (DRI).

### 2. Description of the Related Art

The reduction of materials containing iron oxide by direct reduction with a reducing gas in a reduction unit—for example in a fixed bed or a fluid or fluidized bed—at elevated temperature is known. The solid product of direct reduction is known as sponge iron, or direct reduced iron (DRI). DRI is processed further into, for example, pig iron and steel, such processing including inter alia a melting step.

In addition to metallic iron, DRI also contains iron oxides. In the course of the further processing of DRI, it is often advantageous if the DRI contains carbon. A carbon content of at least 1.5% by weight is for example the aim for further processing. Further processing takes place for example in an arc furnace, a smelter, a submerged arc furnace (SAF) or a steelmaking converter. The carbon provides for example chemical energy through gasification with oxygen, which can be utilized for the heating or reduction of iron oxides. The carbon also helps lower the melting point of an iron melt, which makes melting less energy-consuming. In addition, the carbon is used for the residual reduction of iron oxide in order to minimize losses of iron in the slag that also forms during melting.

In direct reduction processes using carbon-containing reducing gas, carbon is already introduced into the DRI during the direct reduction. The less carbon that is present in the reducing gas, the lower the carbon content of the DRI obtained in the direct reduction. In order to reduce CO2 emissions in iron and steel production, a decrease in the use of carbon-containing reducing gases is sought. This gives rise to the problem of how a sufficiently high carbon content can still be achieved in the further processing of DRIs obtained in this way.

In a direct reduction it is known to additionally supply hydrocarbon-containing gas to the reducing gas for the purpose of carburization, so as to increase the carbon content of the DRI obtained. However, achieving desired carbon contents of above 1.5% by weight is not possible with direct reduction in a fluidized bed or fluid bed. Also, the provision of a downstream carburization reactor in which the DRI is supplied with carbon-containing gas in order to increase the carbon content does not allow the desired carbon contents of above 1.5% by weight to be achieved. The reason for this is that, at the low reduction temperatures, firstly, the solubility limit for dissolved carbon in iron is very low and, secondly, high proportions of Fe3C in the DRI are not achieved through endothermic methane decomposition.

In order to still have sufficient carbon during melting, it is also commonplace to supply carbon or carbon-containing substances during melting. However, the high feed rates that are sometimes necessary make this costly to implement and difficult to accomplish, this being due for example to differences in the density of the DRI and of the liquid slag and of the carbon or carbon-containing substances.

In addition, melting without carbon-induced lowering of the melting point is very energy-intensive, since this requires a higher temperature.

In order to reduce reactivity and thus simplify further processing, DRI is often compacted in a hot state, i.e. as hot sponge iron, or hot direct reduced iron (HDRI). The product of the compaction is hot-briquetted sponge iron, or hot-briquetted iron (HBI), for example when producing briquettes, or hot-compacted sponge iron, or hot-compacted iron (HCl), for example in the case of DRI production in a fluid bed or fluidized bed. Especially in the case of finely particulate HDRI dust, for example from fluidized bed or fluid bed processes, compaction to HBI or HCl helps avoid losses in yield due to dust losses or reoxidation losses.

### SUMMARY OF THE INVENTION

The process and device that make it possible to increase the carbon content of DRI are to be presented. These allow at least some of the discussed existing problems in further processing to be reduced or avoided.

This object is achieved by a process for
introducing carbon into direct reduced iron DRI,
wherein at least one solid carbon carrier is added to the DRI,
characterized in that, after addition of the solid carbon carrier to the DRI, the DRI undergoes compaction.

The carbon is introduced into the DRI via at least one carbon carrier. Carbon carrier is for example is carbon in elemental form, but it can also be a carbon-containing compound or a mixture of different compounds that are at least partly carbon-containing.

The carbon carrier is solid. It is for example coke or anthracite, a more favorable option being biogenic carbon or biological carbon, since this is CO2-neutral.

The solid product of direct reduction is known as sponge iron, or direct reduced iron (DRI).

The DRI produced in a direct reduction unit is preferably added to solid carbon carriers outside the direct reduction unit.

The DRI preferably does not undergo compaction prior to addition of the solid carbon carrier to the DRI: the solid carbon carrier is accordingly added to the DRI obtained in the direct reduction unit without the DRI obtained in the direct reduction unit having been compacted beforehand.

When compacted DRI that has had its carbon content increased in accordance with the invention is sent for further processing, problems arising from the DRI having a low carbon content can be reduced or avoided. For example, if the carbon content is increased, less energy is needed for melting, since the melting point is lowered. The need for carbon to be added during melting and the associated problems likewise decrease; any addition of carbon during melting that is still taking place can be limited to fine adjustment of the carbon content in the melt, with a consequent decrease in the scale of the outlay and associated challenges, for example, a loading system for loading carbon or carbon carriers during melting can be designed smaller. As a result of the addition to DRI, the carbon is in close proximity to iron oxides in the DRI, thereby facilitating reduction by carbon. If a slag is present during melting, iron losses in the slag due to absorption of FeO into the slag can accordingly be decreased.

After addition of the solid carbon carrier to the DRI, the DRI undergoes compaction.

The compaction can for example be compaction to HCl: this is preferable for example when the DRI has been produced by means of a fluidized bed process or a fluid bed process for direct reduction.

Compaction can for example be compaction to HBI, i.e. briquetting.

The compaction together with carbon results in the carbon being finely distributed in the HCl or HBI: when the HCl or HBI is melted in a melting unit, it is accordingly in close proximity to FeO that is to be reduced, which facilitates the residual reduction of FeO. A fine dispersion of carbon in HCl or HBI is also helpful in lowering the melting point.

If the temperature of the DRI undergoing briquetting is above 650° C., the product of DRI compaction is referred to as hot-briquetted sponge iron or hot-briquetted iron (HBI) when its apparent density is above 5.0 g/cm³. For compacted DRI that does not fully meet these criteria, i.e. when the apparent density is less than or equal to 5.0 g/cm3 and/or the temperature of the DRI undergoing briquetting is 650° C. or less, the term hot-compacted iron sponge, or hot-compacted iron (HCl), is commonplace.

HBI and HCl are to be understood in the context of the present application as being as defined above.

Information on HBI can be found for example in HOT BRIQUETTED IRON (HBI) QUALITY ASSESSMENT GUIDE, International Iron Metallics Association May 2020, and in current International Maritime Organization IMO regulations.

According to a preferred embodiment, the DRI is a carbon-free or low-carbon product of a direct reduction with reducing gas. DRI is according to the present application low in carbon if its carbon content is below 1.5% by weight.

The reducing gas preferably comprises hydrogen (H2) as reducing component, the content of hydrogen in % by volume being greater than that of any of the other reducing components optionally present in the reducing gas: the reducing gas preferably comprises hydrogen (H2) to an extent of at least 50% by volume, more preferably to an extent of over 50% by volume. The wording that the reducing gas contains hydrogen (H2) as reducing component implies that the reducing gas consists of hydrogen.

In addition to hydrogen, other components of the reducing gas may also be present in the reducing gas: these may be reducing components.

Other reducing components of the reducing gas are for example carbon monoxide (CO) or hydrocarbons.

The reducing gas preferably comprises ammonia (NH3) as reducing component, the content of ammonia preferably being at least 5% by volume and more preferably over 5% by volume.

The wording that the reducing gas contains ammonia (NH3) as reducing component implies that the reducing gas consists of ammonia.

In addition to ammonia (NH3), other components of the reducing gas may also be present in the reducing gas: these may be reducing components. Other reducing components of the reducing gas are for example carbon monoxide (CO) or hydrocarbons.

According to one embodiment, the DRI is an HDRI.

In the production of HCl, HDRI is transported—preferably from the direct reduction unit—via a conveyor—also termed a riser—to a reservoir vessel known as an HDRI bin. From there it is supplied via a supply line, which comprises for example a screw bunker, to a compacting device, for example a compacting press.

According to a preferred embodiment, the addition of the solid carbon carrier takes place in at least one of the group consisting of:
conveyor to the HDRI bin,
HDRI bin,
supply line, preferably upstream of a screw bunker in the supply line when viewed in the direction of the compacting device,
screw bunker.

According to a preferred embodiment, HCl is added to a melting unit for melting the HCl, the HCl being introduced into the melting unit via an HCl container—also termed HCl bin—and the solid carbon carrier also being added to the HCl bin.

The melting unit is preferably one of the group consisting of:
electric arc furnace (EAF),
submerged arc furnace (SAF),
open slag bath furnace (OSBF),
smelter,
converter vessel.

In a smelter, EAF, OSBF or SAF, melting is at least partially on the basis of electrical energy.

EAF, SAF, and OSBF are not to be understood as smelters in the context of this application.

A converter vessel is for example a steelmaking converter for steel production.

Additives that are employed for example to adjust a slag that is desired during melting, for example to set a desired basicity in the slag, can be supplied to the melting unit. They can also be supplied to the direct reduction unit from which the DRI is obtained, in which case they are present in the DRI. This supply during melting is employed preferably for fine adjustment of the amount of additive during melting.

### BRIEF DESCRIPTION OF THE DRAWINGS

The above-described properties, features, and advantages of this invention and the manner in which they are achieved will become clearer and more clearly comprehensible in conjunction with the following description of embodiments, which are elucidated more particularly in conjunction with the schematic and exemplary drawing. In the FIGURE:

FIG. 1 illustrates schematically the execution of an embodiment of the process of the invention.

### DETAILED DESCRIPTION

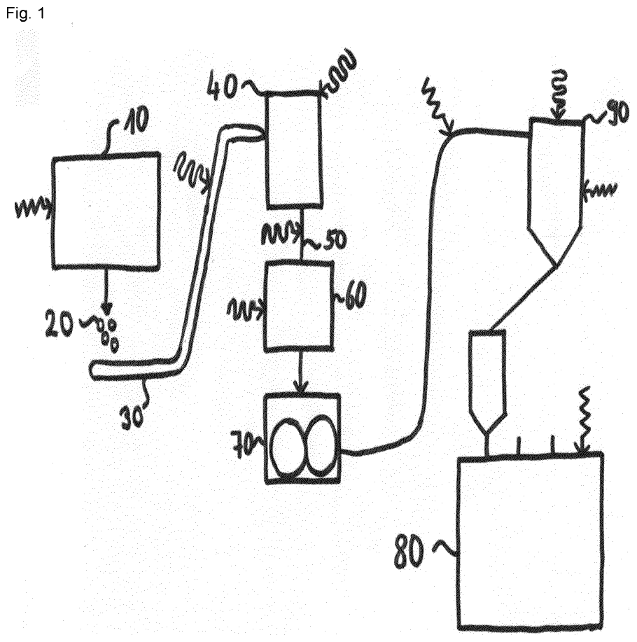

FIG. 1 shows a direct reduction unit 10 in which DRI 20 is produced. It can be for example a direct reduction unit comprising a plurality of fluidized bed reactors preferably operated with hydrogen as the predominating reducing component of the reducing gas. The product of the direct reduction in direct reduction unit 10 is DRI 20; in the illustrated case the DRI 20 is HDRI that is low in carbon on account of the choice of reducing gas, i.e. it contains less than 1.5% by weight of carbon.

The DRI 20 will be compacted into HCl. For this, it is first transported to the HDRI bin 40 via the conveyor 30. From there it is supplied via a supply line 50, which comprises a screw bunker 60, to a compacting device 70. The addition of solid carbon carrier-represented by wavy arrows—to the DRI 20 takes place in at least one of the following places:
conveyor 30 to the HDRI bin 40,
HDRI bin 40,
supply line 50, preferably upstream of a screw bunker 60 in the supply line 50 when viewed in the direction of the compacting device 70,
screw bunker 60.

It is also shown how HCl is added to a melting unit 80—in this case a smelter—for melting the HCl. HCl is introduced into the melting unit 80 via an HCl bin 90. In the example shown, a solid carbon carrier—represented by a wavy arrow—is also added to the HCl bin 90.

The addition of additive(s)—represented by zigzag arrows—can take place in the supply line to the HCl bin 90, into the HCl bin 90, directly into a melting unit 80 and/or into the direct reduction unit 10.

Although the invention has been illustrated and described more particularly by the preferred exemplary embodiments, the invention is not limited by the examples disclosed and other variations can be derived therefrom by a person skilled in the art without departing from the scope of protection of the invention.

### LIST OF REFERENCE NUMERALS

10 Direct reduction unit
20 DRI
30 Conveyor
40 HDRI bin
50 Supply line
60 Screw bunker
70 Compacting device
80 Melting unit
90 HCl bin

1-7. (canceled)

8. A process for introducing carbon into direct reduced iron (DRI) produced in a direct reduction unit, comprising:
adding at least one solid carbon carrier to DRI produced outside the direct reduction unit;
wherein no compaction of the DRI takes place before addition of the solid carbon carrier to the DRI; and
wherein, after addition of the solid carbon carrier to the DRI, the DRI undergoes compaction.

9. The process as claimed in claim 8, wherein the DRI is a carbon-free product of a direct reduction with reduction gas or a low-carbon product of a direct reduction with reduction gas having a carbon content of less than 1.5% by weight.

10. The process as claimed in claim 8, wherein a reducing gas comprises hydrogen (H2) as a reducing component, a content of hydrogen in % by volume being greater than that of any of the other reducing components optionally present in the reducing gas.

11. The process as claimed in claim 10, wherein the content of hydrogen is at least 50% by volume.

12. The process as claimed in claim 11, wherein the content of hydrogen is over 50% by volume.

13. The process as claimed in claim 8, wherein a reducing gas comprises ammonia (NH3) as a reducing component.

14. The process as claimed in claim 13, wherein a content of ammonia is at least 5% by volume.

15. The process as claimed in claim 14, wherein the content of ammonia is over 5% by volume.

16. The process as claimed in claim 8, wherein the DRI is an HIDRI.

17. The process as claimed in claim 8, wherein an addition of solid carbon carrier is performed in at least one of the group consisting of:
conveyor to the HIDRI bin;
HIDRI bin;
supply line; and
screw bunker.

18. The process as claimed in claim 17, wherein the supply line is upstream of the screw bunker in the supply line when viewed in a direction of a compacting device,

19. The process as claimed in claim 8, wherein HCl is added to a melting unit for melting the HCl, the HCl being introduced into the melting unit via an HCl bin and the solid carbon carrier also being added to the HCl bin.
